(19) United States
(12) Patent Application Publication
(10) Pub. No.: US 2026/0076339 A1
(43) Pub. Date: Mar. 19, 2026

(54) COLLAPSIBLE ELEVATED FEEDER

(71) Applicant: Jiangsu Wellspring PET Articles Co., Ltd., Jiangsu (CN)

(72) Inventor: Bin QIU, Jiangsu (CN)

(73) Assignee: Jiangsu Wellspring PET Articles Co., Ltd., Jiangsu (CN)

(21) Appl. No.: 19/026,631

(22) Filed: Jan. 17, 2025

(30) Foreign Application Priority Data
Sep. 14, 2024 (CN) 202422273241.5

(51) Int. Cl. A01K 5/01

(52) U.S. Cl. CPC A01K 5/0114

(57) ABSTRACT

The present disclosure relates to the technical field of pet products, and specifically to a collapsible elevated feeder. The collapsible elevated feeder includes: a mounting frame, where a bottom of the mounting frame is open; a feeding assembly, where the feeding assembly is arranged on the mounting frame; fixing frames, where the fixing frames are symmetrically connected to the bottom of the mounting frame, and first slide rails are symmetrically formed in each of the fixing frames; sliding frames, where the sliding frames are respectively slidably connected to interiors of the first slide rails; and limiting assemblies, where the limiting assemblies are respectively arranged on inner sides of the fixing frames.

### CROSS REFERENCE TO THE RELATED APPLICATIONS

This application is based upon and claims priority to Chinese Patent Application No. 202422273241.5, filed on Sep. 14, 2024, the entire contents of which are incorporated herein by reference.

### TECHNICAL FIELD

The present disclosure relates to the technical field of pet products, and specifically to a collapsible elevated feeder.

### BACKGROUND

With the improvement of living standards, more people begin to keep pets (such as cats and dogs). To make it convenient for pets to eat food, various feeders have been designed. However, conventional feeders available in the market often have a fixed height. Once the pet grows up and becomes taller, such a feeder will no longer be suitable, making it uncomfortable and inconvenient for the pet to eat food.

Therefore, to solve the above problem, a collapsible elevated feeder is devised in the present disclosure.

### SUMMARY

An objective of the present disclosure is to overcome the defects in the prior art and provide a collapsible elevated feeder that can adapt to different growth periods of pets.

Technical solution: To achieve the above objective, the present disclosure provides a collapsible elevated feeder, including:
a mounting frame, where a bottom of the mounting frame is open;
a feeding assembly, where the feeding assembly is arranged on the mounting frame;
fixing frames, where the fixing frames are symmetrically connected to the bottom of the mounting frame, and first slide rails are symmetrically formed in the fixing frames respectively;
sliding frames, where the sliding frames are respectively slidably connected to interiors of the first slide rails; and
limiting assemblies, where the limiting assemblies are arranged on inner sides of the fixing frames.

In the above technical solution, the feeding assembly includes a first feeding bowl and a second feeding bowl.

In the above technical solution, two first grooves are formed on an upper surface of the mounting frame, and the first feeding bowl and the second feeding bowl are respectively arranged in the two first grooves.

In the above technical solution, a bowl holder is connected to an upper surface of the mounting frame, a second groove is formed in the bowl holder, the first feeding bowl and the second feeding bowl are arranged in the second groove, and the first feeding bowl is connected to the second feeding bowl.

In the above technical solution, each of the limiting assemblies includes:
a first connecting member, where the first connecting member is connected to the inner sides of the fixing frames, and a through hole is formed in the first connecting member;
two sliding members, where the two sliding members are symmetrically arranged in the through hole, a receiving cavity is provided in each of the two sliding members, two second slide rails are provided, and each of the two second slide rails is communicated with the receiving cavity and is provided on a side wall of each of the two sliding members;
a second connecting member, where the second connecting member is fixedly connected to proximate ends of the two sliding members;
two fixing members, where the two fixing members are symmetrically fixedly connected to an interior of the through hole, and the two fixing members respectively run through the two second slide rails;
handles, where a first end of each of the handles is connected to a corresponding one of the two sliding members and a second end of each of the handles runs through the first connecting member and extends outward;
limiting members, where the limiting members are respectively fixedly connected to distal ends of the sliding members;
first limiting holes, where the first limiting holes are respectively formed on the inner sides of the two fixing frames, and positions of the first limiting holes respectively correspond to positions of the limiting members; and
second limiting holes, where the second limiting holes are formed at intervals on inner sides of the sliding frames.

In the above technical solution, a spring is fixedly connected between the two sliding members, and the spring is sleeved on the two second connecting members.

In the above technical solution, the collapsible elevated feeder further includes:
third slide rails, where the third slide rails are respectively arranged at edges of two sides of an interior of the mounting frame;
limiting plates, where the limiting plates are respectively connected to the interior of the mounting frame, each of the limiting plates is arranged on a side of a corresponding one of the fixing frames away from the limiting assembly, and a first clearance is defined between each of the limiting plates and a corresponding one of the third slide rails; and
rotating shafts, where the rotating shafts are respectively fixedly connected to sides of the fixing frames adjacent to the third slide rails, and the rotating shafts are respectively slidably connected to interiors of the third slide rails;
where the limiting plates are parallel to the third slide rails, and a length of the limiting plates is less than a length of the third slide rails.

In the above technical solution, the collapsible elevated feeder further includes:
engagement holes, where the engagement holes are formed on two sides of each of the fixing frames; and
first protrusions, where the first protrusions are respectively arranged on two sides of the mounting frame, and each of the first protrusions is on a same side as a corresponding one of the engagement holes.

In the above technical solution, the collapsible elevated feeder further includes:
U-shaped slots, where the U-shaped slots are respectively formed on two sides of each of the fixing frames, the U-shaped slots are configured to be respectively sleeved over the third slide rails, and the U-shaped slots are located respectively above the engagement holes; and
second protrusions, where the second protrusions are respectively arranged on the two sides of the mounting frame adjacent to the U-shaped slots.

In the above technical solution, a horseshoe structure is arranged at a bottom of each of the sliding frames.

In the above technical solution, the collapsible elevated feeder further includes:
anti-skid structures, where the anti-skid structures are respectively arranged at bottoms of the sliding frames.

In the above technical solution, the collapsible elevated feeder further includes:
a placement groove, where the placement groove is provided on one side of the mounting frame, and an arc-shaped groove is provided on one side of the placement groove; and
a collection compartment, where the collection compartment is provided in the placement groove, and one side of the collection compartment is connected to a rotary plate arranged in the arc-shaped groove.

In the above technical solution, a third connecting member is fixedly connected between inner sides of the sliding frames.

In the above technical solution, a limiting ring is connected to a top of an inner side of each of the first grooves.

In the above technical solution, a floating plate is arranged in the first feeding bowl, a second clearance is defined between the floating plate and the first feeding bowl, and a water inlet is formed in a middle part of the floating plate.

In the above technical solution, a plurality of third protrusions are arranged in the second feeding bowl.

In the above technical solution, fourth slide rails are respectively formed on proximate surfaces of the two of the fixing frames, fourth protrusions are respectively arranged on proximate surfaces of the two of the sliding frames, and the fourth protrusions are respectively slidably connected to interiors of the fourth slide rails.

Additional aspects and advantages of the present disclosure will be apparent from the description below, or understood through practice of the present disclosure.

### BRIEF DESCRIPTION OF THE DRAWINGS

FIG. 1 is a schematic structural right view of Embodiment 1 of the present disclosure.

FIG. 2 is a schematic structural left view of Embodiment 1 of the present disclosure.

FIG. 3 is a schematic structural top view of Embodiment 1 of the present disclosure.

FIG. 4 is a schematic structural bottom view of a mounting frame in Embodiment 1 of the present disclosure.

FIG. 5 is a schematic structural cross-sectional view of a fixing frame in Embodiment 1 of the present disclosure.

FIG. 6 is a schematic structural view of the fixing frame in Embodiment 1 of the present disclosure.

FIG. 7 is a schematic structural view of a collection compartment in Embodiment 1 of the present disclosure.

FIG. 8 is a schematic structural assembled view of the fixing frames and the mounting frame in Embodiment 1 of the present disclosure.

FIG. 9 is a schematic structural enlarged view of part A in Embodiment 1 of the present disclosure.

FIG. 10 is an overall schematic structural view of Embodiment 2 of the present disclosure.

The reference numerals respectively represent: 1. fixing frame; 2. first slide rail; 3. second slide rail; 4. third slide rail; 5. sliding frame; 6. mounting frame; 7. first groove; 8. first feeding bowl; 9. second feeding bowl; 10. first connecting member; 11. second connecting member; 12. third connecting member; 13. through hole; 14. sliding member; 15. receiving cavity; 16. fixing member; 17. handle; 18. limiting member; 19. first limiting hole; 20. second limiting hole; 21. spring; 22. limiting plate; 23. rotating shaft; 24. engagement hole; 25. U-shaped slot; 26. first protrusion; 27. second protrusion; 28. anti-skid structure; 29. placement groove; 30. arc-shaped groove; 31. collection compartment; 32. rotary plate; 33. limiting ring; 34. floating plate; 35. water inlet; 36. third protrusion; 37. fourth slide rail; 38. fourth protrusion; 39. bowl holder; 40. second groove.

### DETAILED DESCRIPTION OF THE EMBODIMENTS

To make the objectives, features, and advantages of the present disclosure more comprehensible, the present disclosure will be described in detail below with reference to the accompanying drawings and specific embodiments. It should be noted that the embodiments of the present disclosure and the features in the embodiments may be combined with each other without conflict.

Many specific details are set forth in the following description to provide a full understanding of the present disclosure. However, the present disclosure can also be implemented in other ways different from those described herein, so the scope of protection of the present disclosure is not limited by the specific embodiments disclosed below.

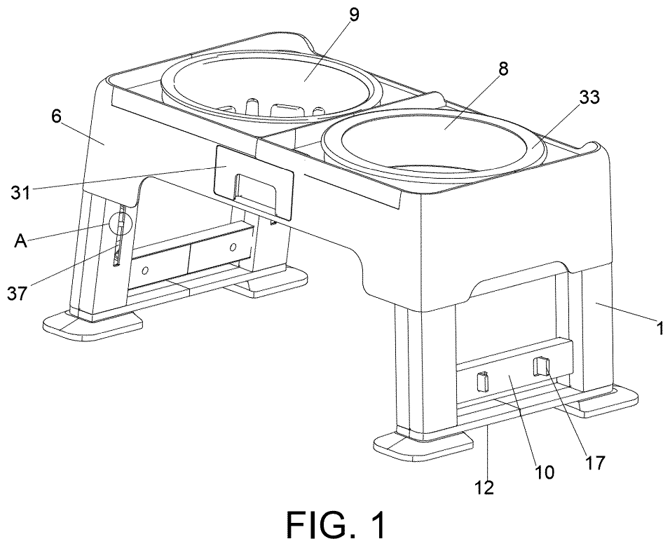

Some embodiments of a collapsible elevated feeder of the present disclosure will be described below with reference to FIG. 1 to FIG. 10.

As shown in FIG. 1 to FIG. 10, an embodiment of the present disclosure provides a collapsible elevated feeder, including: a mounting frame 6, where a bottom of the mounting frame 6 is open; a feeding assembly, where the feeding assembly is arranged on the mounting frame 6; fixing frames 1, where the fixing frames 1 are symmetrically connected to the bottom of the mounting frame 6, and first slide rails 2 are symmetrically formed in the fixing frames 1 respectively; sliding frames 5, where the sliding frames 5 are slidably connected to interiors of the first slide rails 2 respectively; and limiting assemblies, where the limiting assemblies are arranged respectively on inner sides of the fixing frames 1.

With the arrangement of the feeding assembly on the mounting frame 6, water and food can be put into the feeding assembly to feed pets. The fixing frames 1 are symmetrically connected to the bottom of the mounting frame 6. Each of the fixing frames 1 includes two fixing rods and a connecting rod fixedly connected between the two fixing rods. The fixing frames 1 support the mounting frame 6. The first slide rails 2 are symmetrically formed in each of the fixing frames 1, i.e., a first slide rail 2 is formed in each of the fixing rods. The sliding frames 5 can be slidably connected to the interiors of the corresponding first slide rails 2. Each of the sliding frames 5 includes two sliding rods. Each of the sliding rods is respectively slidably connected to the interior of the corresponding first slide rail 2. As such, a height of the feeding assembly can be adjusted by adjusting the sliding frames 5, to meet the feeding requirements of different pets or the feeding requirements of pets in different growth periods, thereby reducing the eating difficulty of pets. The limiting assemblies are respectively arranged on the inner sides of the fixing frames 1. The inner sides of the fixing frames 1 are respective surfaces of the two fixing frames 1 which are opposite to each other. The positions of the sliding frames 5 are respectively fixed by the limiting assemblies, so as to prevent the sliding frames 5 from shaking.

The bottom of the mounting frame 6 is configured to be open, so that the fixing frames 1 can be conveniently inserted into an interior of the mounting frame 6 and mounted. The fixing frames 1 is mounted at two ends of the interior of the mounting frame 6, i.e., the fixing frames 1 are mounted at four corners of the mounting frame 6.

### Embodiment 1

As shown in FIG. 1 to FIG. 3, in an embodiment of the present disclosure, the feeding assembly includes a first feeding bowl 8 and a second feeding bowl 9.

Two first grooves 7 are formed on an upper surface of the mounting frame, and the first feeding bowl 8 and the second feeding bowl 9 are respectively arranged in the two first grooves 7.

The formation of the two first grooves 7 at a top of the mounting frame 6 makes it convenient to place the first feeding bowl 8 and the second feeding bowl 9 into the two first grooves 7, and provides a placement space for the feeding bowls to reduce the shaking of the feeding bowls.

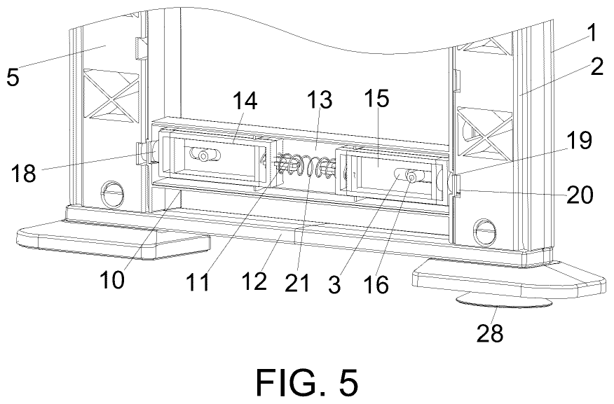

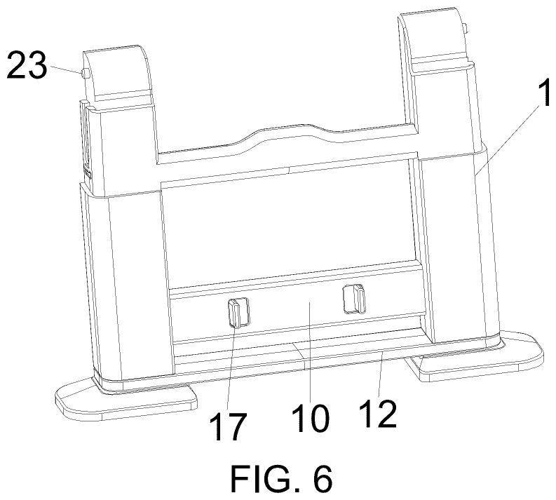

As shown in FIG. 5 and FIG. 6, in an embodiment of the present disclosure, each of the limiting assemblies includes: a first connecting member 10, where the first connecting member 10 is connected to the inner side of the corresponding fixing frame 1, and a through hole 13 is formed in the first connecting member 10; two sliding members 14, where the sliding members 14 are symmetrically arranged in the through hole 13, a receiving cavity 15 is provided in each of the sliding members 14, and a second slide rail 3 in communication with the receiving cavity 15 is provided on a side wall of each of the sliding members 14; a second connecting member 11, where the second connecting member 11 is fixedly connected to proximate ends of the two sliding members 14; two fixing members 16, where the two fixing members 16 are symmetrically fixedly connected to an interior of the through hole 13, and the two fixing members 16 respectively run through the two second slide rails 3; handles 17, where a first end of each of the handles 17 is connected to the corresponding sliding member 14 and a second end of each of the handles 17 runs through the first connecting member 10 and extends outward; limiting members 18, where the limiting members 18 are respectively fixedly connected to distal ends of the two sliding members 14; first limiting holes 19, where the first limiting holes 19 are respectively formed on the inner sides of the two fixing frames 1, and positions of the first limiting holes 19 respectively correspond to positions of the limiting members 18; and second limiting holes 20, where the second limiting holes are formed at intervals on the inner sides of the sliding frames 5.

When the overall height of the collapsible elevated feeder needs to be adjusted, operation personnel firstly pulls the handles 17, each of which has the first end connected to the corresponding sliding member 14 and the second end running through the first connecting member 10 and extending outward, to move toward each other. In the process of the two handles 17 moving toward each other, the two handles 17 drive the sliding members 14 slidably connected to the interior of the through hole 13 to move toward each other, so that the operation personnel can adjust the height of the sliding frames 5. The operation personnel may pull the sliding rods downward to adjust the height of the collapsible elevated feeder to a feeding height required by pets, and then stop pulling the sliding rods. At this moment, the second limiting holes 20 on the inner sides of the sliding frames 5, i.e., the second limiting holes 20 on proximate surfaces of the two sliding rods, correspond to the positions of the limiting members 18 fixedly connected to the distal ends of the two sliding members 14. Then, the operation personnel pulls the handles 17 to move away from each other, so that the sliding members 14 can return to their original positions, and the limiting members 18 respectively pass through the first limiting holes 19 on proximate surfaces of the two fixing rods and extend into interiors of the second limiting holes, to fix the sliding rods and prevent the sliding rods from sliding, thereby improving the stability of the collapsible elevated feeder. The first connecting member 10 is fixedly connected between the two fixing rods, to provide support for the entire limiting assembly. The receiving cavity 15 is provided in each of the sliding members 14, the second slide rail 3 in communication with the receiving cavity 15 is provided on the side wall of each of the sliding members 14, the fixing members 16 are symmetrically fixedly connected to the interior of the through hole 13, and the two fixing members 16 respectively run through the two second slide rails 3. As such, two sides of each sliding member 14 are supported by the corresponding fixing member 16 and the corresponding handle 17, so that the stability of the sliding member 14 is improved.

As shown in FIG. 5, in an embodiment of the present disclosure, a spring 21 is fixedly connected between the two sliding members 14, and the spring 21 is sleeved on the two second connecting members 11.

The spring 21 is fixedly connected between the two sliding members 14, and is sleeved on the two second connecting members 11, so that when the operation personnel releases the handles 17 after adjusting the handles 17, an elastic restoration of the spring 21 can drive the limiting member 18 to move into the corresponding second limiting hole 20. As such, the operation difficulty is reduced.

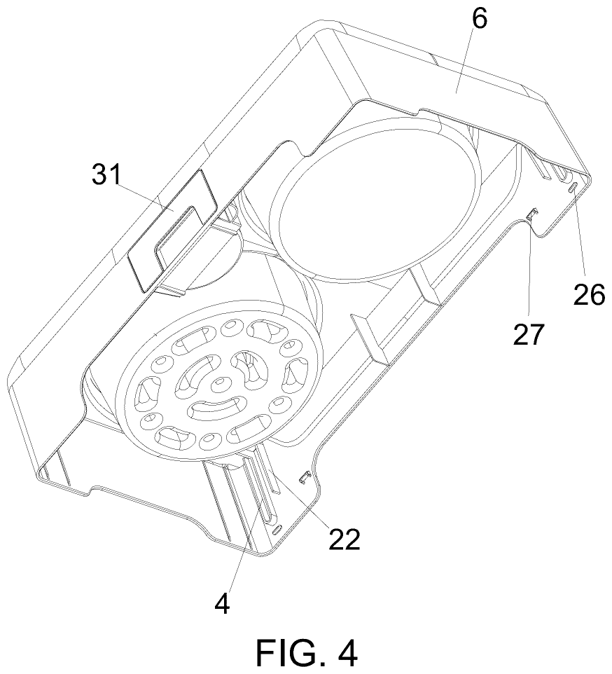

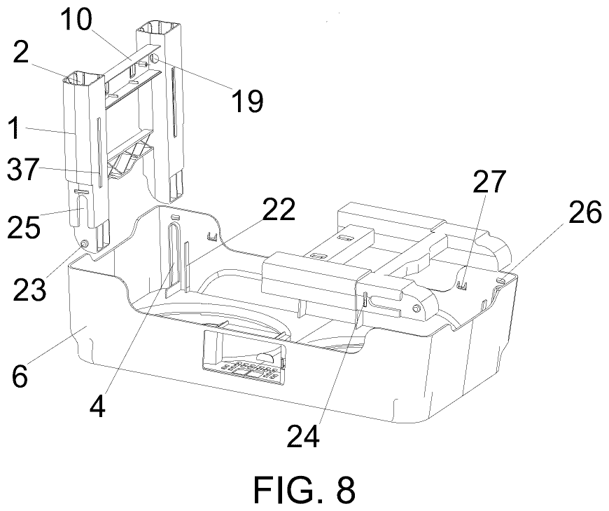

As shown in FIG. 4 and FIG. 8, in an embodiment of the present disclosure, the collapsible elevated feeder further includes: third slide rails 4, where the third slide rails 4 are respectively arranged at edges of two sides of an interior of the mounting frame 6; limiting plates 22, where the limiting plates 22 are respectively connected to the interior of the mounting frame 6, each of the limiting plates 22 is arranged on a side of the corresponding fixing frame 1 away from the limiting assembly, and a first clearance is defined between each of the limiting plates 22 and the corresponding third slide rail 4; and rotating shafts 23, where each of the rotating shafts 23 is fixedly connected to a side of the corresponding fixing frame 1 adjacent to the third slide rails 4, and each of the rotating shafts 23 is slidably connected to interiors of the corresponding third slide rails 4. Each of the limiting plates 22 is parallel to the corresponding third slide rail 4, and a length of each of the limiting plates 22 is less than a length of the corresponding third slide rail 4.

The arrangement of the third slide rails 4 at the edges of the two sides of the interior of the mounting frame 6 ensures that each of the fixing frames 1 can be slid vertically along the corresponding third slide rails 4 by means of the corresponding rotating shafts 23. In addition, when the fixing frame 1 needs to be folded, the operation personnel may pull the fixing frame 1 downward, to cause each of the corresponding rotating shafts 23 to slide to a lowest position on the corresponding third slide rail 4. Because each of the limiting plates 22 is parallel to the corresponding third slide rail 4, and the length of each of the limiting plates 22 is less than the length of the corresponding third slide rail 4, it can be ensured that when each of the rotating shafts 23 has moved to the lowest position, the fixing frame 1 can be rotated toward a middle part of the mounting frame 6 without being blocked by the limiting plates 22, and exactly when the fixing frame 1 is rotated to a horizontal position, the fixing frame 1 is in contact with the limiting plates 22. As such, it is ensured that the fixing frame 1 is arranged horizontally, and the limiting plates 22 function to limit the fixing frame 1.

As shown in FIG. 4 and FIG. 8, in an embodiment of the present disclosure, the collapsible elevated feeder further includes: engagement holes 24, where the engagement holes 24 are formed on two sides of each of the fixing frames 1; and first protrusions 26, where the first protrusions 26 are respectively arranged on two sides of the mounting frame 6, and each of the first protrusions 26 is on the same side as the corresponding engagement hole 24.

To use the collapsible elevated feeder, the fixing frames 1 are rotated, so that the fixing frames 1 are vertically placed on ground. Then, the fixing frames 1 are pushed upward, to cause the fixing frames 1 to slide upward along the corresponding third slide rails 4 by means of the corresponding rotating shafts 23, until each of the rotating shafts 23 moves to a top of the corresponding third slide rail 4. Exactly at this moment, the engagement holes 24 on the two sides of each of the fixing frames 1 reach the corresponding first protrusions 26. The first protrusions 26 on the two sides of the mounting frame 6 respectively enter the engagement holes 24, and the first protrusions 26 are in interference fit with the corresponding engagement holes 24, thereby preventing the fixing frames 1 from shaking and improving the stability of the collapsible elevated feeder during use.

As shown in FIG. 4, FIG. 6, and FIG. 8, in an embodiment of the present disclosure, the collapsible elevated feeder further includes: U-shaped slots 25, where the U-shaped slots 25 are respectively formed on two sides of each of the fixing frames 1, each of the U-shaped slots 25 is configured to be sleeved over the corresponding third slide rail 4, and each of the U-shaped slots 25 is located above the corresponding engagement hole 24; and second protrusions 27, where the second protrusions 27 are respectively arranged on the two sides of the mounting frame 6 adjacent to the U-shaped slots 25.

Each of the U-shaped slots 25 has an opening facing upward. An end of each of the U-shaped slots 25 adjacent to the corresponding limiting plate 22 extends into the corresponding first clearance. The first clearance provides a function of guiding the U-shaped slot 25. The end of each of the U-shaped slots 25 adjacent to the corresponding limiting plate 22 is in contact with the corresponding third slide rail 4 and the corresponding limiting plate 22. As such, the U-shaped slots 25 are limited, and the stability of the fixing frames 1 is further improved. When the collapsible elevated feeder does not need to be used, the fixing frames 1 are pulled downward, so that the first protrusions 26 are disengaged from the corresponding engagement holes 24, the U-shaped slots 25 on the two sides of each of the fixing frames 1 slide downward, and the U-shaped slots 25 sleeved over the third slide rails 4 move downward, until each of the rotating shafts 23 moves to a bottom of the corresponding third slide rail 4. At this moment, the U-shaped slots 25 are disengaged from the corresponding third slide rails 4. Because the length of each of the limiting plates 22 is less than the length of the corresponding third slide rail 4, it can be ensured that each of the fixing frames 1 can be rotated toward the middle part of the mounting frame 6 by means of the corresponding rotating shafts 23. During the upward rotation of the U-shaped slots 25, the U-shaped slots 25 will be respectively blocked by the second protrusions 27 on the two sides of the mounting frame 6 and adjacent to the U-shaped slots 25. The second protrusions 27 are made of rubber. Therefore, the fixing frames 1 are further pushed upward to cause the second protrusions 27 to deform, until the second protrusions 27 are respectively engaged with the U-shaped slots 25. The U-shaped slots 25 are respectively limited by the second protrusions 27, to prevent the fixing frames 1 from rotating downward. In addition, the limiting effect of the limiting plates 22 can prevent the fixing frames 1 from rotating upward, thereby keeping the fixing frames 1 always horizontal.

As shown in FIG. 1, in an embodiment of the present disclosure, a horseshoe structure is arranged at a bottom of each of the sliding frames 5.

The arrangement of the horseshoe structure at the bottom of each of the sliding frames 5 can increase the contact area of the collapsible elevated feeder with the ground, and therefore improve the stability of the collapsible elevated feeder. The horseshoe structure extends into the bottom of the sliding frame 5 and is in interference fit with the sliding frame 5 to prevent the horseshoe structure from detaching from the bottom of the sliding frame 5.

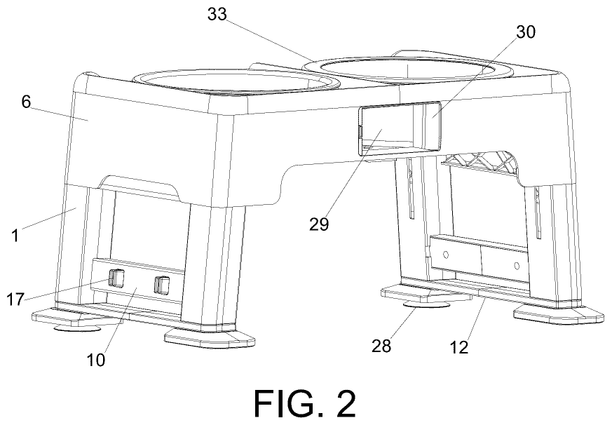

As shown in FIG. 2, in an embodiment of the present disclosure, the collapsible elevated feeder further includes: anti-skid structures 28, where the anti-skid structures 28 are respectively arranged at bottoms of the sliding frames 5.

The anti-skid structures 28 arranged at the bottoms of the sliding frames 5 may be suction cups or anti-skid pads, which can reduce the skidding of the collapsible elevated feeder, thereby further improving the stability of the collapsible elevated feeder during use.

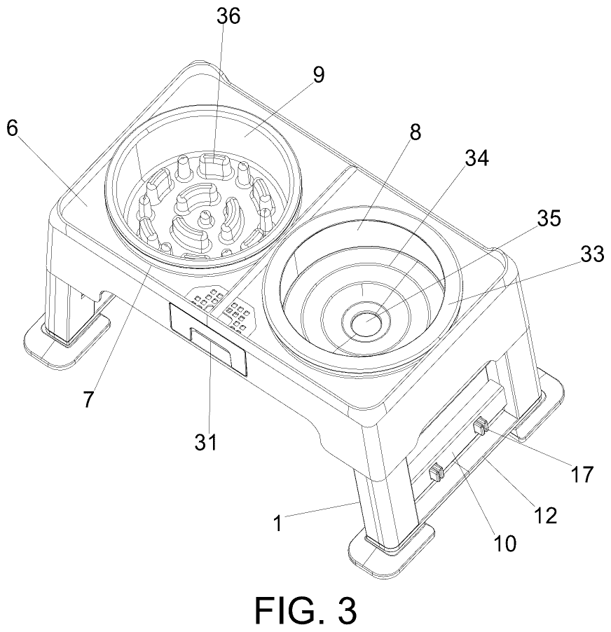

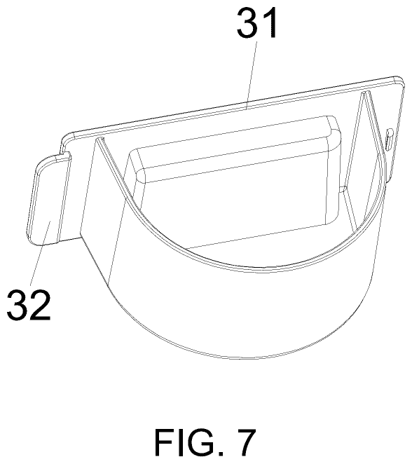

As shown in FIG. 1, FIG. 2, FIG. 3, FIG. 7, and FIG. 8, in an embodiment of the present disclosure, the collapsible elevated feeder further includes: a placement groove 29, where the placement groove 29 is provided on one side of the mounting frame 6, and an arc-shaped groove 30 is provided on one side of the placement groove 29; and a collection compartment 31, where the collection compartment 31 is provided in the placement groove 29, and one side of the collection compartment 31 is connected to a rotary plate 32 arranged in the arc-shaped groove 30.

Because the placement groove 29 is provided on one side of the mounting frame 6 and the collection compartment 31 is provided in the placement groove 29, residue splashed when pets is eating pet food can be collected into the collection compartment 31, so that the cleaning difficulty is reduced.

As shown in FIG. 1 to FIG. 3, in an embodiment of the present disclosure, a third connecting member 12 is fixedly connected to an inner side of each of the sliding frames 5.

The arrangement of the third connecting member 12 fixedly connected to the inner side of each of the sliding frames 5 can ensure that the components inside the sliding frame 5 can be moved vertically at the same time, thereby reducing the adjustment difficulty.

As shown in FIG. 1 to FIG. 3, in an embodiment of the present disclosure, a limiting ring 33 is connected to a top of an inner side of each of the first grooves 7.

The limiting ring 33 is connected to the top of the inner side of each of the first grooves 7, and the limiting rings 33 are respectively located above the first feeding bowl 8 and the second feeding bowl 9, to limit the first feeding bowl 8 and the second feeding bowl 9 and prevent the first feeding bowl 8 and the second feeding bowl 9 from being taken away by pets.

As shown in FIG. 3, in an embodiment of the present disclosure, a floating plate 34 is arranged in the first feeding bowl 8, a second clearance is defined between the floating plate 34 and the first feeding bowl 8, and a water inlet 35 is formed in a middle part of the floating plate 34.

The floating plate 34 is arranged in the first feeding bowl 8, and the density of the floating plate 34 is less than the density of water, so that the floating plate 34 can float when water is poured into the first feeding bowl 8. The second clearance between the floating plate 34 and the first feeding bowl 8 can ensure that the floating plate 34 can float normally without being obstructed by the first feeding bowl 8. The water inlet 35 is provided in the middle part of the floating plate 34 for pets to drink water. Limited by the floating plate 34, a pet can only drink water through the water inlet 35. As such, the drinking speed of the pet can be reduced, thereby reducing safety hazards.

As shown in FIG. 3, in an embodiment of the present disclosure, a plurality of third protrusions 36 are arranged in the second feeding bowl 9.

With the arrangement of the plurality of third protrusions 36 in the second feeding bowl 9, the eating speed of pets can be reduced by the third protrusions 36, so that the safety of pets during eating can be improved.

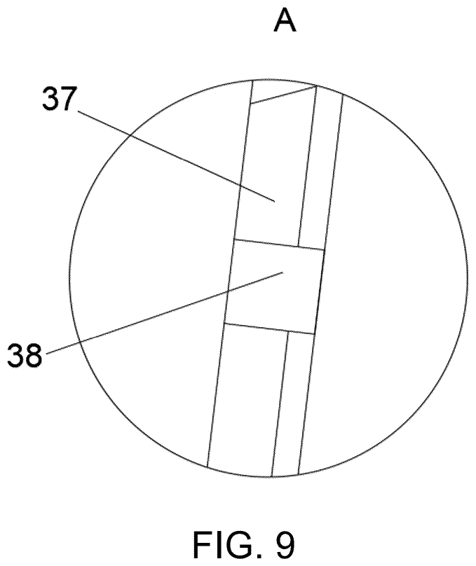

As shown in FIG. 8 and FIG. 9, in an embodiment of the present disclosure, fourth slide rails 37 are respectively formed on proximate surfaces of the two fixing frames 1, fourth protrusions 38 are respectively arranged on proximate surfaces of the two sliding frames 5, and each of the fourth protrusions 38 is slidably connected to an interior of the corresponding fourth slide rail 37.

The fourth slide rails 37 are respectively formed on the proximate surfaces of the two fixing frames 1, and the fourth protrusions 38 respectively slidably connected to the interiors of the fourth slide rails 37 are respectively arranged on the proximate surfaces of the two sliding frames 5. As such, once the sliding frame 5 falls from the hand of the operation personnel in the process of the operation personnel pulling the sliding frame 5 downward, the fourth protrusions 38 can be respectively limited by the corresponding fourth slide rails 37 and thus suspended at bottoms of the corresponding fourth slide rails 37. Therefore, the fixing frame 1 functions to limit the sliding frame 5, to prevent the sliding frame 5 from completely falling out from the inside of the fixing frame 1, thereby reducing the difficulty of subsequent assembly.

### Embodiment 2

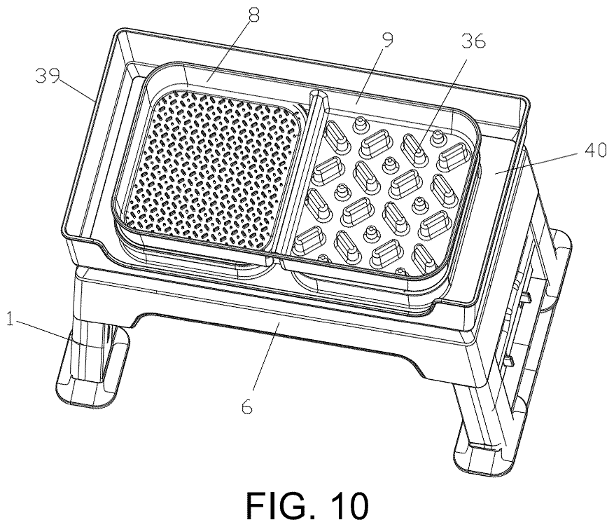

As shown in FIG. 10, in an embodiment of the present disclosure, a bowl holder 39 is connected to an upper surface of the mounting frame 6, a second groove 40 is formed in the bowl holder 39, the first feeding bowl 8 and the second feeding bowl 9 are arranged in the second groove 40, and the first feeding bowl 8 is connected to the second feeding bowl 9.

The bowl holder 39 is fixedly connected to the upper surface of the mounting frame 6, and the second groove 40 is provided on the upper surface of the bowl holder 39, so that the first feeding bowl 8 and the second feeding bowl 9 connected to each other can be put into the second groove 40. With the arrangement of the bowl holder 39, residue generated by pets during eating can fall into the bowl holder 39 and thus be collected. The bowl holder 39 is removable mounted on the mounting frame 6, and can be removed and cleaned regularly.

As shown in FIG. 5 and FIG. 6, in an embodiment of the present disclosure, each of the limiting assemblies includes: a first connecting member 10, where the first connecting member 10 is connected to the inner side of the corresponding fixing frame 1, and a through hole 13 is formed in the first connecting member 10; two sliding members 14, where the sliding members 14 are symmetrically arranged in the through hole 13, a receiving cavity 15 is provided in each of the sliding members 14, and a second slide rail 3 in communication with the receiving cavity 15 is provided on a side wall of each of the sliding members 14; a second connecting member 11, where the second connecting member 11 is fixedly connected to proximate ends of the two sliding members 14; two fixing members 16, where the two fixing members 16 are symmetrically fixedly connected to an interior of the through hole 13, and the two fixing members 16 respectively run through the two second slide rails 3; handles 17, where a first end of each of the handles 17 is connected to the corresponding sliding member 14 and a second end of each of the handles 17 runs through the first connecting member 10 and extends outward; limiting members 18, where the limiting members 18 are respectively fixedly connected to distal ends of the two sliding members 14; first limiting holes 19, where the first limiting holes 19 are respectively formed on the inner sides of the two fixing frames 1, and positions of the first limiting holes 19 respectively correspond to positions of the limiting members 18; and second limiting holes 20, where the second limiting holes are formed at intervals on the inner sides of the sliding frames 5.

When the overall height of the collapsible elevated feeder needs to be adjusted, operation personnel firstly pulls the handles 17, each of which has the first end connected to the corresponding sliding member 14 and the second end running through the first connecting member 10 and extending outward, to move toward each other. In the process of the two handles 17 moving toward each other, the two handles 17 drive the sliding members 14 slidably connected to the interior of the through hole 13 to move toward each other, so that the operation personnel can adjust the height of the sliding frames 5. The operation personnel may pull the sliding rods downward to adjust the height of the collapsible elevated feeder to a feeding height required by pets, and then stop pulling the sliding rods. At this moment, the second limiting holes 20 on the inner sides of the sliding frames 5, i.e., the second limiting holes 20 on proximate surfaces of the two sliding rods, correspond to the positions of the limiting members 18 fixedly connected to the distal ends of the two sliding members 14. Then, the operation personnel pulls the handles 17 to move away from each other, so that the sliding members 14 can return to their original positions, and the limiting members 18 respectively pass through the first limiting holes 19 on proximate surfaces of the two fixing rods and extend into interiors of the second limiting holes, to fix the sliding rods and prevent the sliding rods from sliding, thereby improving the stability of the collapsible elevated feeder. The first connecting member 10 is fixedly connected between the two fixing rods, to provide support for the entire limiting assembly. The receiving cavity 15 is provided in each of the sliding members 14, the second slide rail 3 in communication with the receiving cavity 15 is provided on the side wall of each of the sliding members 14, the fixing members 16 are symmetrically fixedly connected to the interior of the through hole 13, and the two fixing members 16 respectively run through the two second slide rails 3. As such, two sides of each sliding member 14 are supported by the corresponding fixing member 16 and the corresponding handle 17, so that the stability of the sliding member 14 is improved.

As shown in FIG. 5, in an embodiment of the present disclosure, a spring 21 is fixedly connected between the two sliding members 14, and the spring 21 is sleeved on the two second connecting members 11.

The spring 21 is fixedly connected between the two sliding members 14, and is sleeved on the two second connecting members 11, so that when the operation personnel releases the handles 17 after adjusting the handles 17, an elastic restoration of the spring 21 can drive the limiting member 18 to move into the corresponding second limiting hole 20. As such, the operation difficulty is reduced.

As shown in FIG. 4 and FIG. 8, in an embodiment of the present disclosure, the collapsible elevated feeder further includes: third slide rails 4, where the third slide rails 4 are respectively arranged at edges of two sides of an interior of the mounting frame 6; limiting plates 22, where the limiting plates 22 are respectively connected to the interior of the mounting frame 6, each of the limiting plates 22 is arranged on a side of the corresponding fixing frame 1 away from the limiting assembly, and a first clearance is defined between each of the limiting plates 22 and the corresponding third slide rail 4; and rotating shafts 23, where each of the rotating shafts 23 is fixedly connected to a side of the corresponding fixing frame 1 adjacent to the third slide rails 4, and each of the rotating shafts 23 is slidably connected to interiors of the corresponding third slide rails 4. Each of the limiting plates 22 is parallel to the corresponding third slide rail 4, and a length of each of the limiting plates 22 is less than a length of the corresponding third slide rail 4.

The arrangement of the third slide rails 4 at the edges of the two sides of the interior of the mounting frame 6 ensures that each of the fixing frames 1 can be slid vertically along the corresponding third slide rails 4 by means of the corresponding rotating shafts 23. In addition, when the fixing frame 1 needs to be folded, the operation personnel may pull the fixing frame 1 downward, to cause each of the corresponding rotating shafts 23 to slide to a lowest position on the corresponding third slide rail 4. Because each of the limiting plates 22 is parallel to the corresponding third slide rail 4, and the length of each of the limiting plates 22 is less than the length of the corresponding third slide rail 4, it can be ensured that when each of the rotating shafts 23 has moved to the lowest position, the fixing frame 1 can be rotated toward a middle part of the mounting frame 6 without being blocked by the limiting plates 22, and exactly when the fixing frame 1 is rotated to a horizontal position, the fixing frame 1 is in contact with the limiting plates 22. As such, it is ensured that the fixing frame 1 is arranged horizontally, and the limiting plates 22 function to limit the fixing frame 1.

As shown in FIG. 4 and FIG. 8, in an embodiment of the present disclosure, the collapsible elevated feeder further includes: engagement holes 24, where the engagement holes 24 are formed on two sides of each of the fixing frames 1; and first protrusions 26, where the first protrusions 26 are respectively arranged on two sides of the mounting frame 6, and each of the first protrusions 26 is on the same side as the corresponding engagement hole 24.

To use the collapsible elevated feeder, the fixing frames 1 are rotated, so that the fixing frames 1 are vertically placed on ground. Then, the fixing frames 1 are pushed upward, to cause the fixing frames 1 to slide upward along the corresponding third slide rails 4 by means of the corresponding rotating shafts 23, until each of the rotating shafts 23 moves to a top of the corresponding third slide rail 4. Exactly at this moment, the engagement holes 24 on the two sides of each of the fixing frames 1 reach the corresponding first protrusions 26. The first protrusions 26 on the two sides of the mounting frame 6 respectively enter the engagement holes 24, and the first protrusions 26 are in interference fit with the corresponding engagement holes 24, thereby preventing the fixing frames 1 from shaking and improving the stability of the collapsible elevated feeder during use.

As shown in FIG. 4, FIG. 6, and FIG. 8, in an embodiment of the present disclosure, the collapsible elevated feeder further includes: U-shaped slots 25, where the U-shaped slots 25 are respectively formed on two sides of each of the fixing frames 1, each of the U-shaped slots 25 is configured to be sleeved over the corresponding third slide rail 4, and each of the U-shaped slots 25 is located above the corresponding engagement hole 24; and second protrusions 27, where the second protrusions 27 are respectively arranged on the two sides of the mounting frame 6 adjacent to the U-shaped slots 25.

Each of the U-shaped slots 25 has an opening facing upward. An end of each of the U-shaped slots 25 adjacent to the corresponding limiting plate 22 extends into the corresponding first clearance. The first clearance provides a functions of guiding the U-shaped slot 25. The end of each of the U-shaped slots 25 adjacent to the corresponding limiting plate 22 is in contact with the corresponding third slide rail 4 and the corresponding limiting plate 22. As such, the U-shaped slots 25 are limited, and the stability of the fixing frames 1 is further improved. When the collapsible elevated feeder does not needed to be used, the fixing frames 1 are pulled downward, so that the first protrusions 26 are disengaged from the corresponding engagement holes 24, the U-shaped slots 25 on the two sides of each of the fixing frames 1 slide downward, and the U-shaped slots 25 sleeved over the third slide rails 4 move downward, until each of the rotating shafts 23 moves to a bottom of the corresponding third slide rail 4. At this moment, the U-shaped slots 25 are disengaged from the corresponding third slide rails 4. Because the length of each of the limiting plates 22 is less than the length of the corresponding third slide rail 4, it can be ensured that each of the fixing frames 1 can be rotated toward the middle part of the mounting frame 6 by means of the corresponding rotating shafts 23. During the upward rotation of the U-shaped slots 25, the U-shaped slots 25 will be respectively blocked by the second protrusions 27 on the two sides of the mounting frame 6 and adjacent to the U-shaped slots 25. The second protrusions 27 are made of rubber. Therefore, the fixing frames 1 are further pushed upward to cause the second protrusions 27 to deform, until the second protrusions 27 are respectively engaged with the U-shaped slots 25. The U-shaped slots 25 are respectively limited by the second protrusions 27, to prevent the fixing frames 1 from rotating downward. In addition, the limiting effect of the limiting plates 22 can prevent the fixing frames 1 from rotating upward, thereby keeping the fixing frames 1 always horizontal.

As shown in FIG. 10, in an embodiment of the present disclosure, a horseshoe structure is arranged at a bottom of each of the sliding frames 5.

The arrangement of the horseshoe structure at the bottom of each of the sliding frames 5 can increase the contact area of the collapsible elevated feeder with the ground, and therefore improve the stability of the collapsible elevated feeder. The horseshoe structure extends into the bottom of the sliding frame 5 and is in interference fit with the sliding frame 5 to prevent the horseshoe structure from detaching from the bottom of the sliding frame 5.

As shown in FIG. 2, in an embodiment of the present disclosure, the collapsible elevated feeder further includes: anti-skid structures 28, where the anti-skid structures 28 are respectively arranged at bottoms of the sliding frames 5.

The anti-skid structures 28 arranged at the bottoms of the sliding frames 5 may be suction cups or anti-skid pads, which can reduce the skidding of the collapsible elevated feeder, thereby further improving the stability of the collapsible elevated feeder during use.

As shown in FIG. 1 to FIG. 3, in an embodiment of the present disclosure, a third connecting member 12 is fixedly connected to an inner side of each of the sliding frames 5.

The arrangement of the third connecting member 12 fixedly connected to the inner side of each of the sliding frames 5 can ensure that the components inside the sliding frame 5 can be moved vertically at the same time, thereby reducing the adjustment difficulty.

As shown in FIG. 10, in an embodiment of the present disclosure, a plurality of third protrusions 36 are arranged in the second feeding bowl 9.

With the arrangement of the plurality of third protrusions 36 in the second feeding bowl 9, the eating speed of pets can be reduced by the third protrusions 36, so that the safety of pets during eating can be improved.

As shown in FIG. 8 and FIG. 9, in an embodiment of the present disclosure, fourth slide rails 37 are respectively formed on proximate surfaces of the two fixing frames 1, fourth protrusions 38 are respectively arranged on proximate surfaces of the two sliding frames 5, and each of the fourth protrusions 38 is slidably connected to an interior of the corresponding fourth slide rail 37.

The fourth slide rails 37 are respectively formed on the proximate surfaces of the two fixing frames 1, and the fourth protrusions 38 respectively slidably connected to the interiors of the fourth slide rails 37 are respectively arranged on the proximate surfaces of the two sliding frames 5. As such, once the sliding frame 5 falls from the hand of the operation personnel in the process of the operation personnel pulling the sliding frame 5 downward, the fourth protrusions 38 can be respectively limited by the corresponding fourth slide rails 37 and thus suspended at bottoms of the corresponding fourth slide rails 37. Therefore, the fixing frame 1 functions to limit the sliding frame 5, to prevent the sliding frame 5 from completely falling out from the inside of the fixing frame 1, thereby reducing the difficulty of subsequent assembly.

The present disclosure has the following advantages.

1. The fixing frames 1 are respectively mounted in the mounting frames 6, and the sliding frames 5 are respectively slidably connected to the interiors of the first slide rails 2. As such, the overall height of the collapsible elevated feeder can be controlled by adjusting the positions of the sliding frames 5, so that the height of the collapsible elevated feeder can meet the feeding requirements of pets in different growth periods. In addition, the collapsible elevated feeder is also suitable for pets of different body shapes can also be used. Therefore, the range of applications of the collapsible elevated feeder is broadened.

2. The limiting assemblies are respectively arranged on the inner sides of the fixing frames 1. The heights of the sliding frames 5 can be fixed by the corresponding limiting assemblies, so as to prevent the sliding frames 5 from being shifted during use.

In the present disclosure, the terms such as “mount”, “connect”, “couple”, “fix”, and variants thereof should be interpreted in a broad sense. For example, “connection” may be a fixed connection, a detachable connection, or an integral connection; and “connection” may also be a direct connection or an indirect connection through an intermediate medium. For those of ordinary skill in the art, the specific meanings of the above terms in the present disclosure can be understood according to specific circumstances.

In the description of the present disclosure, it should be understood that the orientation or positional relationships indicated by the terms such as “inner” and “outer” are based on orientation or position relationships shown in the accompanying drawings, and are used only for ease and brevity of illustration and description, rather than indicating or implying that the mentioned apparatus or unit must have a particular orientation or must be constructed and operated in a particular orientation. Therefore, such terms should not be construed as limiting of the present disclosure.

In the description of this specification, the description with reference to the terms such as “an embodiment”, “some embodiments”, and “specific embodiment” means that specific features, structures, materials, or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments or examples.

The above description is merely preferred embodiments of the present disclosure, and is not intended to limit the present disclosure. To those skilled in the art, various modifications and variations may be made to the present disclosure. Any modification, equivalent replacement, or improvement made without departing from the spirit and principle of the present disclosure shall fall within the scope of protection of the present disclosure.

What is claimed is:

1. A collapsible elevated feeder, comprising:
a mounting frame, wherein a bottom of the mounting frame is open;
a feeding assembly, wherein the feeding assembly is arranged on the mounting frame;
fixing frames, wherein the fixing frames are symmetrically connected to the bottom of the mounting frame, and first slide rails are symmetrically formed in the fixing frames respectively;
sliding frames, wherein the sliding frames are respectively slidably connected to interiors of the first slide rails; and
limiting assemblies, wherein the limiting assemblies are arranged on inner sides of the fixing frames.

2. The collapsible elevated feeder according to claim 1, wherein the feeding assembly comprises a first feeding bowl and a second feeding bowl.

3. The collapsible elevated feeder according to claim 2, wherein
two first grooves are formed on an upper surface of the mounting frame, and the first feeding bowl and the second feeding bowl are respectively arranged in the two first grooves.

4. The collapsible elevated feeder according to claim 2, wherein
a bowl holder is connected to an upper surface of the mounting frame, a second groove is formed in the bowl holder, the first feeding bowl and the second feeding bowl are arranged in the second groove, and the first feeding bowl is connected to the second feeding bowl.

5. The collapsible elevated feeder according to claim 1, wherein
each of the limiting assemblies comprises:
a first connecting member, wherein the first connecting member is connected to the inner sides of the fixing frames, and a through hole is formed in the first connecting member;
two sliding members, wherein the two sliding members are symmetrically arranged in the through hole, a receiving cavity is provided in each of the two sliding members, two second slide rails are provided, and each of the two second slide rails is communicated with the receiving cavity and is provided on a side wall of each of the two sliding members;
a second connecting member, wherein the second connecting member is fixedly connected to proximate ends of the two sliding members;
two fixing members, wherein the two fixing members are symmetrically fixedly connected to an interior of the through hole, and the two fixing members respectively run through the two second slide rails;
handles, wherein a first end of each of the handles is connected to a corresponding one of the two sliding members and a second end of each of the handles runs through the first connecting member and extends outward;
limiting members, wherein the limiting members are respectively fixedly connected to distal ends of the two sliding members;
first limiting holes, wherein the first limiting holes are respectively formed on the inner sides of the fixing frames, and positions of the first limiting holes respectively correspond to positions of the limiting members; and
second limiting holes, wherein the second limiting holes are formed at intervals on inner sides of the sliding frames.

6. The collapsible elevated feeder according to claim 5, wherein
a spring is fixedly connected between the two sliding members, and the spring is sleeved on the two second connecting members.

7. The collapsible elevated feeder according to claim 1, further comprising:
third slide rails, wherein the third slide rails are respectively arranged at edges of two sides of an interior of the mounting frame;
limiting plates, wherein the limiting plates are respectively connected to the interior of the mounting frame, each of the limiting plates is arranged on a side of a corresponding one of the fixing frames away from the limiting assembly, and a first clearance is defined between each of the limiting plates and a corresponding one of the third slide rails; and
rotating shafts, wherein the rotating shafts are respectively fixedly connected to sides of the fixing frames adjacent to the third slide rails, and the rotating shafts are respectively slidably connected to interiors of the third slide rails;
wherein the limiting plates are parallel to the third slide rails, and a length of the limiting plates is less than a length of the third slide rails.

8. The collapsible elevated feeder according to claim 7, further comprising:
engagement holes, wherein the engagement holes are formed on two sides of each of the fixing frames; and
first protrusions, wherein the first protrusions are respectively arranged on two sides of the mounting frame, and each of the first protrusions is on a same side as a corresponding one of the engagement holes.

9. The collapsible elevated feeder according to claim 8, further comprising:
U-shaped slots, wherein the U-shaped slots are respectively formed on two sides of each of the fixing frames, the U-shaped slots are configured to be respectively sleeved over the third slide rails, and the U-shaped slots are located respectively above the engagement holes; and
second protrusions, wherein the second protrusions are respectively arranged on the two sides of the mounting frame adjacent to the U-shaped slots.

10. The collapsible elevated feeder according to claim 1, wherein
a horseshoe structure is arranged at a bottom of each of the sliding frames.

11. The collapsible elevated feeder according to claim 1, further comprising:
anti-skid structures, wherein the anti-skid structures are respectively arranged at bottoms of the sliding frames.

12. The collapsible elevated feeder according to claim 1, further comprising:
a placement groove, wherein the placement groove is provided on one side of the mounting frame, and an arc-shaped groove is provided on one side of the placement groove; and
a collection compartment, wherein the collection compartment is provided in the placement groove, and one side of the collection compartment is connected to a rotary plate arranged in the arc-shaped groove.

13. The collapsible elevated feeder according to claim 1, wherein
a third connecting member is fixedly connected between inner sides of the sliding frames.

14. The collapsible elevated feeder according to claim 3, wherein
a limiting ring is connected to a top of an inner side of each of the first grooves.

15. The collapsible elevated feeder according to claim 3, wherein
a floating plate is arranged in the first feeding bowl, a second clearance is defined between the floating plate and the first feeding bowl, and a water inlet is formed in a middle part of the floating plate.

16. The collapsible elevated feeder according to claim 2, wherein
a plurality of third protrusions are arranged in the second feeding bowl.

17. The collapsible elevated feeder according to claim 1, wherein
fourth slide rails are respectively formed on proximate surfaces of the two of the fixing frames, fourth protrusions are respectively arranged on proximate surfaces of the two of the sliding frames, and the fourth protrusions are respectively slidably connected to interiors of the fourth slide rails.
